(19) United States
(12) Patent Application Publication
(10) Pub. No.: US 2011/0261700 A1
(43) Pub. Date: Oct. 27, 2011

(54) METHOD FOR CONNECTING NETWORK SEGMENTS HAVING REDUNDANCY PROPERTIES TO ANY NETWORK

(76) Inventor: Werner Maisch, Neuffen (DE)

(21) Appl. No.: 13/121,188

(22) PCT Filed: Oct. 2, 2009
(86) PCT No.: PCT/EP09/07082

§ 371 Date: Jul. 19, 2011

(30) Foreign Application Priority Data
Oct. 2, 2008 (DE) 10 2008 049 944.7

(51) Int. Cl. H04L 12/26

(52) U.S. Cl. 370/241

(57) ABSTRACT

The invention relates to a method for operating a local network, particularly an Ethernet network, having redundancy properties, wherein in a closed ring a redundancy manager monitors the sections of said ring, and wherein according to the invention at least one additional ring is connected as a partial ring which does not contain a redundancy manager, and segment controllers at both ends of the partial ring take on the monitoring of said partial ring by sending control packets into said partial ring.

The invention relates to a method of operating a local area network, in particular, an ethernet network having redundancy properties and in which a redundancy manager in a closed ring monitors the links of this ring as set forth in the features of the preamble of claim 1.

A local area network, in particular, an ethernet network having redundancy properties, has been disclosed in DE 198 10 587 [U.S. Pat. No. 5,430,151]. A single ring (multiple network infrastructure devices, such as, for example, switches, are interconnected through lines, for example, cables, to form a ring) always also includes a redundancy manager that interrupts data transmission if the ring is closed or enables data transmission when the ring is interrupted. In DE 198 10 587 A1, a redundancy manager connected to the line ends checks the state of a single ring. To this end, the redundancy manager at one line end sends a test packet message through the line to a port of the one network infrastructure device that relays the test packet message through the following lines and the following network infrastructure devices to the other line end, and checks whether the message is being received at the other line end. In the no-failure case, the redundancy manager isolates the two line ends from each other, while in the case of a failure it connects the line ends.

When two individual rings are interconnected, this occurs through common network nodes and common links where a redundancy manager would be located in each complete ethernet ring. When a common link fails or is reestablished, in the worst case both redundancy managers react simultaneously and thereby cause a loop or cause individual network segments to be inaccessible.

Due to the common link, the response of the ring managers is mutually dependent in the connected rings. Each ring must be configured differently so that only one redundancy manager reacts to the failure or reestablishment of a common link.

In EP 1 729 453 A1, two rings are connected to each other through a common link in the ring, where in each ring a ring manager (=redundancy manager) monitors the state of its ring. When the common link is interrupted, only one ring manager is notified about the change in the common link. To do this, however, it is absolutely necessary that the ring managers be configured differently.

There thus exists a dependency between the parameters in the individual rings. This has consequences, in particular, when the configuration of the ring managers is incorrect. If two ring managers have set the same parameters or ring managers react simultaneously, this will have unpredictable consequences for the stability and switching of the rings, and last but not least for the accessibility of the network participants.

The object of the invention is to avoid the disadvantages described above.

This object is achieved by the features of claim 1.

The invention provides that at least one additional ring be connected in the form of a subring that does not include a redundancy manager, and segment controllers at both ends of the subring take on the task of monitoring this subring by sending control packets into this subring.

Within a closed ring, in particular, an ethernet ring, a redundancy manager continues to monitor in unchanged fashion the links of this ring.

An additional ring is connected as a subring that does not include a redundancy manager (or ring manager). New segment controllers at both ends of the subring take on the task of monitoring the subring by sending control packets into this subring. This ensures that the control packets used to monitor this subring do not have to pass through a common link, and as a result are independent of any changes in other rings, subrings, or network segments.

The reaction to a change in a ring or subring is restricted to the associated ring or subring. Different reaction times can thus be permitted in each ring segment, thereby making it possible to join rings, in particular, ethernet rings, of varying design.

An interruption in one ring segment has no effect at all on another ring segment, i.e. an interruption is allowed to exist in every ring segment.

This has the advantage that when two networks having a ring structure are connected only one entity is permitted to monitor each link in these rings. There are no longer any common links, with the result that the dependency is eliminated between network segments, rings, and the redundancy managers.

Each network node in each connected subring may be configured in exactly identical fashion. This has enormous advantages for the user. Having only one single configuration for all network nodes in the subrings significantly reduces the cost in time for configuring the ring network. In addition, the risk of a faulty response due to an erroneous configuration is significantly reduced, an aspect that in turn significantly minimizes the cost of troubleshooting. The use only needs to configure the segment controllers. The control packets must be differentiated when multiple network segments are connected to the same segment controllers, as is also the case when an additional subring is connected within a subring.

The following discussion once again summarizes the invention including its essential and significant aspects:

In order to connect a network segment having redundancy properties to any given network, segment controllers are located at both ends of the network segment to be connected.

The network segment together with the two segment controllers is connected to an existing network in such a way that the two segment controllers are inserted into the existing network.

When, for example, a network segment is connected to an ethernet ring, the two network controllers of this network segment must be located in the same ethernet ring.

Each segment controller is continually sending control packets into the connected network segment. The segment controllers detect an interruption of the network segment based on the absence of these control packets. If a segment controller receives the control packets on the respective other end of the network segment, the network segment is closed. Control packets do not leave the associated network segment.

In a closed network segment, one of the two segment controllers at the line ends of this network segment has blocked a line end for data traffic. A segment controller receives and sends only control packets over a port that is blocked for data traffic.

Each segment controller makes the decision based on the content of the control packets as to which of two segment controllers is blocking its line end. The ethernet MAC address of the participating segment controllers, in particular, is used for this purpose. The segment controller with the higher ethernet MAC address blocks the line end of a closed network segment.

Instructions for the network nodes in the network segment can be included in the control packets. Each network node in the connected network segment receives the control packet and reacts to instructions.

Distinguishing features in the control packets enable multiple network segments to be connected to the same segment controller simultaneously, as well as additional network segments to be connected within an existing network segment.

There must not be any redundancy manager or ring manager located in a network segment connected by means of segment controllers.

When a connection fails in the network segment connected by segment controllers, the network nodes at the interrupted point notify the segment controllers about the interruption, whereupon the segment controller with the blocked line end immediately enables this line end for data transmission.

When an interrupted connection is reestablished, each network node first keeps the port of this connection blocked. Only the control packets of the segment controllers are then received and relayed through this blocked port. The instruction to the network nodes in the network segment to enable data transmission is effected by a segment controller. To do this, a segment controller communicates to this network node the time of the enabling in the control packet. At this time, one of the two segment controllers then blocks the line end of the network segment, while simultaneously all address tables in the network segment are deleted and the instructed network node in the network segment enables its port for transmission.

The following discussion describes the method of connecting an ethernet subring to an ethernet ring. However, the method can also be applied to connecting any network segment having redundancy properties to any network.

The method here thus involves a local area network, in particular, an ethernet network, having redundancy properties, and is employed principally to connect ethernet subrings to an ethernet ring. The network formation thus created can also be viewed as an interconnected combination of ethernet rings.

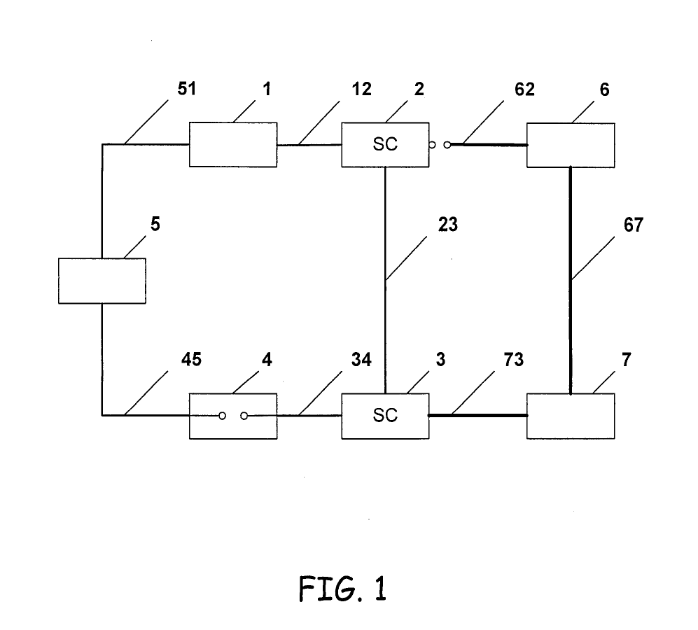

FIG. 1 illustrates a network having a ring structure. network nodes 1 through 5 are connected by lines (=lines=cables) 12, 23, 34, 45 and 51 to form a ring in which the network node 4 has the role of a redundancy manager and has interrupted data traffic when the ring is closed.

In order to be able to connect an additional network segment having redundancy properties to this ring, the network nodes 2 and 3 take over the role of a segment controller (“SC”). A linear network segment including devices 6 and 7, and a connection 67 is connected by lines 62 and 73 to the network nodes 2 and 3.

Each segment controller continuously sends control packets through ports that are provided to connect network segments, in this case to the ports that are connected to lines 62 and 73, and thus monitors the state of the network segments.

The ports of the segment controllers that are connected to the lines 62 and 73 initially remain blocked for data traffic. At the blocked ports, the segment controllers receive only their control packets. As soon as a segment controller receives the control packets of the respective other segment controller through the lines 62 or 73, it is able to detect which who has the higher ethernet MAC address based on the ethernet MAC address of the sender contained in the control packets. The network node with the higher ethernet MAC address causes the line end to be blocked as long as it is receiving the control packets of the other. In this example, network node 2 would have the higher ethernet MAC address, whereupon this node has link 62 blocked for data traffic, while the network node 3 enables the link 73 for transmission of the data traffic. Control packets do not leave the associated network segment. In this example, the control packets that are sent and received at the connections 62 and 73 are not relayed to the connections 12, 23, or 34.

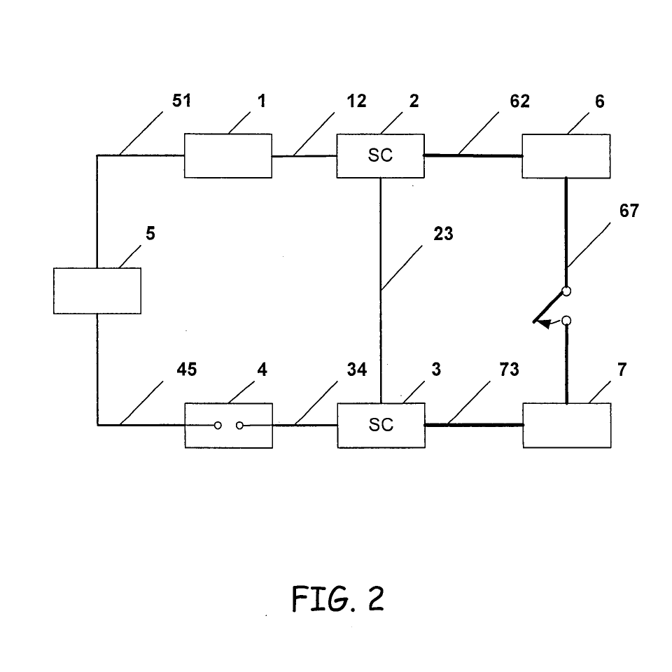

In FIG. 2, the connection 67 is interrupted. Based on the absence of control packets, the segment controllers 2 and 3 detect that the network segment has been interrupted, whereupon the segment controller 2 enables its port, which is connected to line 62 and still blocked, for the transmission of data traffic. In order to reestablish data transmission to the network node 6 more quickly when the connection 67 fails, the network nodes 6 and 7 can send a message to the segment controllers, the message indicating the failure of a connection. In response, segment controller 2 immediately enables its blocked port for transmission, while segment controller 3 can ignore this message since the connection 73 is already transmitting.

Once the connection 67 has been reestablished, the network nodes 6 and 7 cause their respective ports connected to the line 67 to initially be blocked. Only control packets of the segment controllers are received and relayed through the blocked connection 67. This enables the segment controllers 2 and 3 to receive control packets from the respective other segment controllers, and thus to determine that a network segment has been reestablished. Based on the ethernet MAC address, the two segment controllers recognize who of the two is blocking the line end of the network segment during a switching operation. The segment controller with the higher ethernet MAC address communicates in its control packets to all network nodes the time of switching. When the time of switching has arrived, the segment controller 2 in this example blocks the connection 62, the network nodes 2, 3, 6 and 7 delete their address tables, and the network nodes 6 and 7 enable the connection 67 for data transmission.

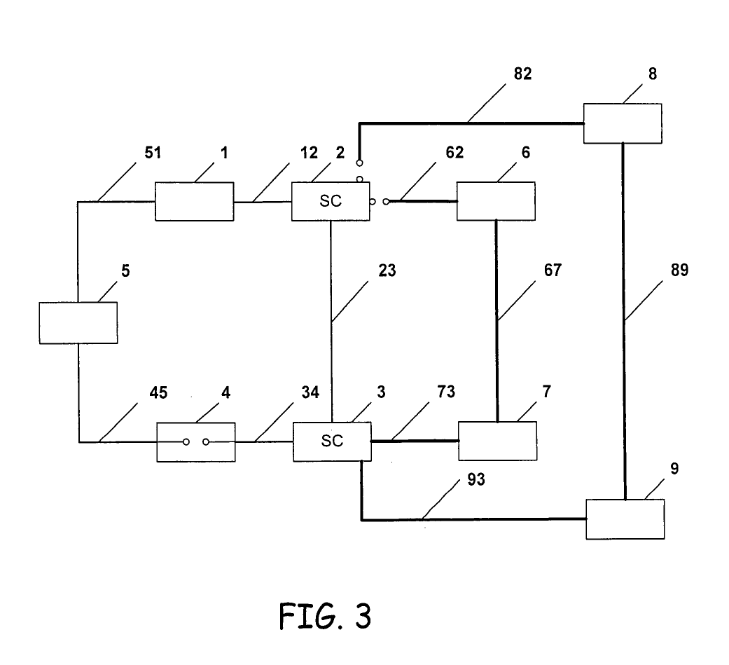

In FIG. 3, another network segment together including the network nodes 8 and 9, and a connection 89, is connected through lines 82 and 93 to the segment controllers 2 and 3. In order to enable the segment controllers to differentiate the individual network segments, distinguishing features are provided in the control packets.

In each network segment, the switching operations proceed independently of each other. Each segment controller reacts only to changes in the associated network segment. An interruption of the connection 67 results only in the enabling of data transmission for the connection 62, not, however, for the connection 82. Furthermore, a simultaneous interruption of the connections 23 and 51 does not result in transmission being enabled for the connections 82 or 62.

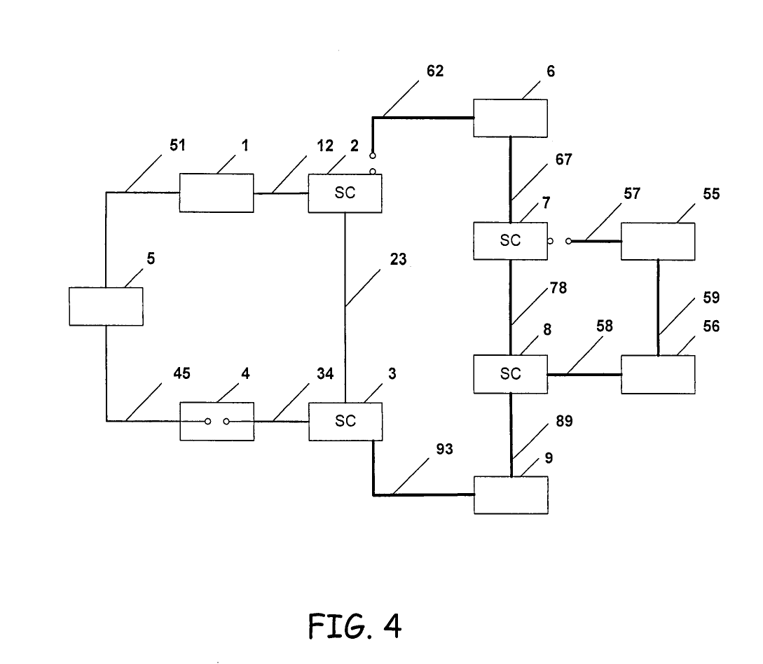

FIG. 4 illustrates a ring including the network nodes 1 through 5 to which a network segment including the network nodes 6 through 9 is connected through segment the controllers 2 and 3, to which network segment in turn a network segment including the network nodes 55 and 56 is connected at the segment controllers 7 and 8. The control packets of the segment controllers 2 and 3 must be differentiated from the control packets of the segment controllers 7 and 8. An interruption of the connections 78 thus results only in enabling data transmission for the connection 62, but not the connection 57. The segment controllers 7 and 8 send their control packets only into the connections 57 and 58, but not into the connections 67, 68, or 89. Simultaneously, the segment controllers 7 and 8 also receive the control packets of the segment controllers 2 and 3, and follow the instructions contained in these control packets for the switching operation of the associated network segment.

When a network segment is connected to a ring, the two subring controllers must be located in the same ring. This also applies if it is only a subring. The network segment including the network nodes 6 through 9 in FIG. 4 is considered to be a subring.

As a result, an additional network segment including the network nodes 55 and 56 can be connected since the associated the subring controllers 7 and 8 are located in this subring.

No stand-alone rings can be connected to each other using this method. If the network nodes 7, 8, 55 and 56 were to form a ring in FIG. 4, with the network nodes 55 as the redundancy manager, this ring could not be connected to the ring composed of the network nodes 1 through 5 including the network nodes 2, 3, 7 and 8 as segment controllers. The segment controllers 2 and 7 could only monitor the connections 62 and 67, but could not react to an interruption in the connection 89 or 93, and both rings remain isolated from each other.

1. A method of operating a local area ethernet network having redundancy properties and in which a redundancy manager in a closed ring monitors the links of this ring, wherein at least one additional ring is connected as a subring that does not contain a redundancy manager, and segment controllers at both ends of the subring take on the task of monitoring this subring by sending control packets into this subring.

2. The method according to claim 1, wherein a reaction to a change in a ring or subring is restricted to the associated ring or subring.

3. The method according to claim 1, wherein each network node is configured in exactly identical fashion in each connected subring.

4. The method according to claim 1, wherein the two segment controllers of this network segment are located in the same ethernet ring, when a network segment is connected to an ethernet ring.

5. The method according to claim 1, wherein each segment controller sends control packets into the connected network segment, and the segment controllers detect an interruption of the network segment based on the absence of these control packets, whereas conversely the network segment is closed whenever a segment controller receives the control packets at the respective other end of the network segment.

6. The method according to claim 1, wherein in a closed network segment one of the two segment controllers at the line ends of this network segment blocks the respective line end for data traffic, and a segment controller receives and sends only control packets through a port that is blocked for data traffic.

7. The method according to claim 1, wherein each segment controller makes the decision as to which of two segment controllers blocks its line end based on the content of control packets, the ethernet MAC address, of the two participating segment controllers being used for this purpose, and the segment controller with the higher ethernet MAC address blocks the line end of a closed network segment.

8. The method according to claim 1, wherein, when a connection fails in the network segment connected by segment controllers, the network nodes at the interrupted point notify the segment controllers about the interruption, whereupon the segment controller with the blocked line end immediately enables this line end for data traffic.

9. The method according to claim 1, wherein when an interrupted connection is reestablished each network node initially keeps the port of this connection blocked so that only control packets of the segment controllers are then received and relayed through this blocked port.

10. The method according to claim 1, wherein the instruction to the network nodes in the network segment to enable data traffic is effected by a segment controller, to which end a segment controller communicates to this network node in the control packet the time of the enabling, and then one of the two segment controllers blocks the line end of the network segment at this time, wherein simultaneously all address tables in this network segment are deleted and the instructed network node in this network to segment enables its port for transmission.
